(19) United States
(12) Patent Application Publication
(10) Pub. No.: US 2026/0184458 A1
(43) Pub. Date: Jul. 2, 2026

(54) PACKAGING AND METHODS OF PRODUCTION THEREOF

(71) Applicant: McCormick (UK) Limited, Edinburgh (GB)

(72) Inventors: Laurence LE GAL, Edinburgh (GB); Mark FARRELL, London (GB); Nicola SMITH, London (GB); Massimo ZONCA, Castel Giovanni - PC (IT); Atul BALI, Leamington (CA); Viju VASISHTA, Royston (GB)

(21) Appl. No.: 19/120,502

(22) PCT Filed: Oct. 13, 2023
(86) PCT No.: PCT/GB2023/052670

§ 371 Date: Apr. 11, 2025

(30) Foreign Application Priority Data
Oct. 13, 2022 (GB) 2215144.3

(51) Int. Cl. B65D 1/34; A23L 27/60; B32B 1/00; B32B 7/12; B32B 25/06; B65B 7/28; B65B 25/00; B65D 25/14; B65D 65/46; B65D 77/20; B65D 85/72

(52) U.S. Cl. CPC B65D 1/34; A23L 27/63; B32B 1/00; B32B 7/12; B32B 25/06; B65B 7/2878; B65B 25/001; B65D 25/14; B65D 65/466; B65D 77/2024; B65D 85/72; B32B 2307/7163; B32B 2307/718; B32B 2307/7376; B32B 2439/70

(57) ABSTRACT

The present invention relates to a compostable food packaging comprising: a) a compostable moulded tray having an interior cavity for receiving a foodstuff, an opening through which the foodstuff can be accessed, and a lip extending at least partially around the opening; b) wherein the compostable moulded tray forms a compostable barrier, or wherein the compostable moulded tray comprises a compostable barrier film extended over, and bonded to, the interior cavity and lip of the tray by means of a paper and biofilm heat seal adhesive; and c) a compostable lid which is peelably adhered around the opening and extending to the lip using a peelable adhesive. The packaging is particularly useful for producing single serve sauce pots for quick serve restaurants and take-away outlets, but could also be used for single serve cooking sauces and concentrated stock. The invention also relates to methods of producing such a compostable food packaging.

### FIELD

The present invention relates to compostable packaging and methods of producing such packaging. In particular, the invention relates to compostable single use packaging which is specifically adapted for liquid foodstuffs, such as sauces.

### BACKGROUND

Single serve packaging is problematic from an environmental point of view, as typically not all of the components are recyclable or compostable. This can be confusing for the consumer who can be unsure how to best dispose of the packaging after use and as a result of this, the packaging is often simply placed in the general waste. Some single serve sachets or ‘dipping’ pots containing sauces (such as tomato ketchup, mayonnaise, barbeque sauce, mustard etc) in quick serve restaurants and take away outlets pose a particular problem as the sauces need to have a reasonable shelf life of between six to twelve months and are often transported long distances before being delivered to a particular restaurant or outlet. Due to the relatively small size of single serve sachets or dipping pots, these types of packaging are difficult to recycle given the different materials which are used and contamination with unused product. Therefore, whilst developing a recyclable packaging would be preferable, given the difficulties with the small product format, developing a compostable packaging would make more of a positive environmental impact in the short term.

Due to the high water content in sauces, it has proven difficult for the packaging industry to provide a compostable single serve packaging which is suitable as compostable materials generally start to decompose quickly in the presence of moisture.

Muti-component packaging, where the user physically has to deconstruct the packaging into separate components, has been suggested and has been used for a number of foodstuffs such as fresh meat and fish. However, such packaging is unsuitable for sauces given the sticky and messy nature of sauces and the consumption environment where ease and speed of food consumption (and subsequent disposal of its related packaging) is a primary driver for the experience.

There is an unmet need in the packaging industry to provide compostable single serve packaging. It would be desirable that such compostable single serve packaging were completely compostable, that is to say that all components were composable. It would further be desirable to provide a compostable single serve packaging that was suitable for sauces (such as tomato ketchup) and also enable the sauces to have a long shelf life. It would also be advantageous if such single serve packaging were as easy to use as existing single serve packaging.

### SUMMARY OF THE INVENTION

It is one aim of the present invention, amongst others, to provide compostable packaging that addresses at least one disadvantage of the prior art, whether identified here or elsewhere, or to provide an alternative to existing compostable packaging.

In accordance with a first aspect of the present invention, there is provided a compostable food packaging comprising:
a) a compostable moulded tray having an interior cavity for receiving a foodstuff, an opening through which the foodstuff can be accessed, and a lip extending at least partially around the opening;
b) wherein the compostable moulded tray forms a compostable barrier, or wherein the compostable moulded tray comprises a compostable barrier film extended over, and bonded to, the interior cavity and lip of the tray by means of a paper and biofilm heat seal adhesive; and
c) a compostable lid which is peelably adhered around the opening and extending to the lip using a peelable adhesive.

The barrier or barrier film may be formed from a number of materials which will be apparent to the skilled addressee. The barrier or barrier film may be formed of a compostable bio-resin material. Compostable bio-resin materials (particularly those suited to the present invention) will be apparent and well understood by the skilled addressee. The barrier or barrier film may comprise polyimides and/or epoxy resins.

The barrier or barrier film may be formed of a single layer or multiple layers. If the barrier film is formed of multiple layers, each layer may be applied separately or simultaneously. The barrier or barrier film may be extruded into a sheet.

The lid may comprise a number of compostable materials. Preferably, the lid is formed of a cellulose and one or more polymers. The underside of lid may comprise a peelable adhesive. In certain embodiment, the peelable adhesive is formed using a heat seal lacquer. The heat seal lacquer will preferably be a biodegradable or compostable lacquer. In alternative embodiments, the peelable adhesive is a cold seal adhesive.

The heat seal adhesive may comprise a polyurethane. The polyurethane may comprise one or more of the following: 5-Chloro-2-methyl-4-isothiazolin-3-one and/or 2-Methyl-4-isothiazolin-3-one.

Where the compostable moulded tray comprises a compostable barrier film extended over, and bonded to, the interior cavity and lip of the tray by means of a paper and biofilm heat seal adhesive:
The compostable moulded tray may be a compostable moulded fibre tray. The compostable moulded fibre tray may be a dry moulded fibre tray. Alternatively, the moulded fibre tray may be wet moulded or semi-wet moulded.
The heat seal adhesive may be applied at a dry coat weight in the range of about 10 gsm to about 24 gsm. Preferably, the heat seal adhesive is applied at a dry coat weight in the range of about 12 gsm to about 20 gsm. More preferably, the heat seal adhesive is applied at a dry coat weight in the range of about 14 gsm.
Preferably, the barrier film may be greater than or equal to about 110 μm thick. More preferably the barrier film is greater than or equal to about 135 μm thick. Most preferably, the barrier film is greater than or equal to about 150 μm thick.
In a highly preferable example, the barrier film may be in the range of about 150 μm to about 170 μm thick.
The barrier film may be extruded into a sheet and/or extruded directly onto the moulded fibre tray. The barrier film may be at least partially spray coated to the tray.

The barrier film may be thermoformed at a temperature in a range of about 100° C. to about 110° C.

Where the compostable moulded tray forms a compostable barrier:
The thickness of the compostable barrier may be in the range of about 100 μm to about 600 μm, preferably in the range of about 400 μm to about 600 μm.
The thickness of the compostable barrier may be about 400 μm and may be formed of three layers where each layer is approximately 130 μm thick.
Each layer may be formed of a compostable bio-resin material.
A middle layer may comprise a compostable material which is an oxygen scavenger, for example wherein the middle layer comprise vegetable byproducts, such as those derived from coffee bean skins.
The compostable barrier may be thermoformed at a temperature in the range of about 100° C. to about 170° C., preferably at a temperature in the range of about 100° C. to about 120° C., most preferably in a range of about 105° C. to about 120° C.
The compostable barrier may be thermoformed with a thermoforming dwell time of less than about 1000 ms, preferably with a thermoforming dwell time of less than about 800 ms, most preferably with a thermoforming dwell time of less than about 700 ms.
The method may comprise urging the lid against the opening under heated conditions so as to heat seal the cavity using the lid, preferably at a temperature of less than about 200° C., more preferably at a temperature of at or less than 170° C., most preferably at a temperature in a range of about 160° C. to 170° C.

Where the compostable moulded tray forms a compostable barrier:
The compostable moulded tray may be impregnated with the compostable barrier material, for example by the barrier material being interspersed in fibres of the compostable moulded fibre tray in the region of, or proximal to, the interior cavity. This may be referred to as the compostable moulded tray and compostable barrier being integrally formed or integrally provided.

In a related embodiment to the first aspect, there is provided a compostable food packaging comprising:
a) a compostable moulded fibre tray having an interior cavity for receiving a foodstuff, an opening through which the foodstuff can be accessed, and a lip extending at least partially around the opening;
b) a spray coated compostable barrier film extended over, and bonded to, the interior cavity and lip of the tray; and
c) a compostable lid which is peelably adhered around the opening and extending to the lip using a peelable adhesive.

In a yet further related embodiment to the first aspect, there is provided a compostable food packaging comprising:
a) a compostable moulded fibre tray having an interior cavity for receiving a foodstuff, an opening through which the foodstuff can be accessed, and a lip extending at least partially around the opening;
b) a compostable barrier material impregnated throughout the moulded fibre tray; and
c) a compostable lid which is peelably adhered around the opening and extending to the lip using a peelable adhesive.

The food packaging will preferably further comprise a foodstuff within the cavity. Such a foodstuff may be a liquid foodstuff. The foodstuff may be a sauce, such as a condiment and may be one or more of the following: tomato ketchup, barbeque sauce, mayonnaise, mustard sauce, chili sauce, ranch dressing, curry sauce, and sweet and sour sauce.

In accordance with a second aspect of the present invention, there is provided a method of producing a compostable food packaging comprising:
a) providing a compostable moulded tray having an interior cavity for receiving a foodstuff and an opening through which the foodstuff can be accessed and a lip extending at least partially around the opening;
b) wherein the providing the compostable moulded tray forms a compostable barrier film, or wherein the method further comprises applying and/or forming and bonding, by means of a paper and biofilm heat seal, a compostable barrier film over the interior cavity and lip of the tray;
c) providing a compostable lid and applying it around the opening and at least part of the lip by means of a compostable peelable adhesive; and
d) urging the lid against the opening under heated conditions so as to heat seal the cavity using the lid.

Prior to step c), a liquid food stuff may be placed in the cavity.

Step d) may be undertaken at about 120° C. and/or at about 450 lbf and/or for about 1 second.

Where the method comprises applying and/or forming and bonding a compostable barrier film:
The bond strength between the barrier film and the tray is stronger than the bond strength created by the heat seal adhesive between the barrier film and the compostable lid.
The barrier film may be applied to the interior cavity and lip of the tray by applying hot air to the film and applying negative pressure to the exterior of the tray. The hot air may be in the range of about 120° C. and 140° C., but is preferably in the range of about 136° C. In another example, the hot air may be in the range of about 100° C. to about 110° C. The hot air is dispensed using a hot air gun. The hot air gun may be moved from a distance of about 200 mm from the barrier film to about 100 mm from the barrier film for up to about 2 to about 4 seconds. The hot air gun may be moved from a distance of about 190 mm from the barrier film to about 85 mm from the barrier film for up to about 4 seconds.
The barrier film may be at least partially applied to the interior cavity and lip of the tray by spray coating.

Where providing the compostable moulded tray forms a compostable barrier:
The compostable barrier may be thermoformed at a temperature in the range of about 100° C. to about 170° C., preferably at a temperature in the range of about 100° C. to about 120° C., most preferably in a range of about 105° C. to about 120° C.
The compostable barrier may be thermoformed with a thermoforming dwell time of less than about 1000 ms, preferably with a thermoforming dwell time of less than about 800 ms, most preferably with a thermoforming dwell time of less than about 700 ms.
The urging may be performed preferably at a temperature of less than about 200° C., more preferably at a temperature of at or less than 170° C., most preferably at a temperature in a range of about 160° C. to 170° C.

Where the compostable moulded tray forms a compostable barrier:
The compostable moulded tray may be impregnated with the compostable barrier material, for example by the barrier material being interspersed in fibres of the compostable moulded fibre tray in the region of, or proximal to, the interior cavity.
The compostable moulded tray and compostable barrier material may be integrally formed.

In a related embodiment to the second aspect, there is provided a method of producing a compostable food packaging comprising:
a) providing a compostable moulded fibre tray having an interior cavity for receiving a foodstuff and an opening through which the foodstuff can be accessed and a lip extending at least partially around the opening;
b) applying and/or forming a compostable barrier film over the interior cavity and lip of the tray by spray coating the compostable barrier thereto;
c) providing a compostable lid and applying it around the opening and at least part of the lip by means of a compostable peelable adhesive; and
d) urging the lid against the opening under heated conditions so as to heat seal the cavity using the lid.

In an alternative embodiment to the second aspect, there is provided a method of producing a compostable food packaging comprising:
a) providing a compostable moulded fibre tray having an interior cavity for receiving a foodstuff and an opening through which the foodstuff can be accessed and a lip extending at least partially around the opening;
b) impregnating a compostable barrier material throughout the tray;
c) providing a compostable lid and applying it around the opening and at least part of the lip by means of a compostable peelable adhesive; and
d) urging the lid against the opening under heated conditions so as to heat seal the cavity using the lid.

The method of the second aspect (and related embodiment) may be used to produce a compostable food packaging according to the first aspect (and related embodiment).

The invention is described below, by way of example only, with reference to the accompanying figures in which:

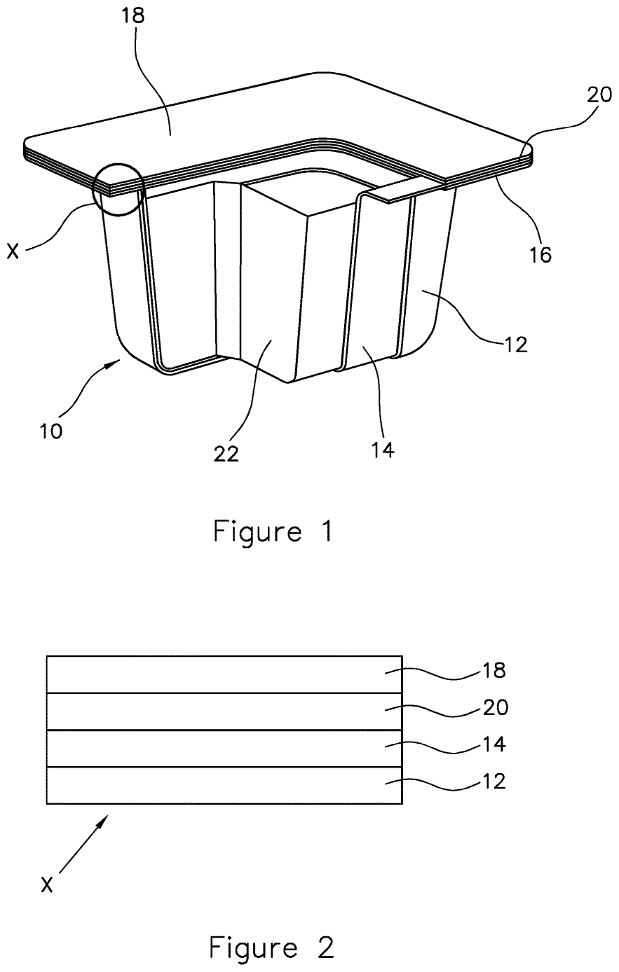

FIG. 1 is a perspective cut-away view of an embodiment of a compostable packaging in accordance with the present invention.

FIG. 2 is a schematic cross-sectional view of the compostable packaging in area X as denoted in FIG. 1.

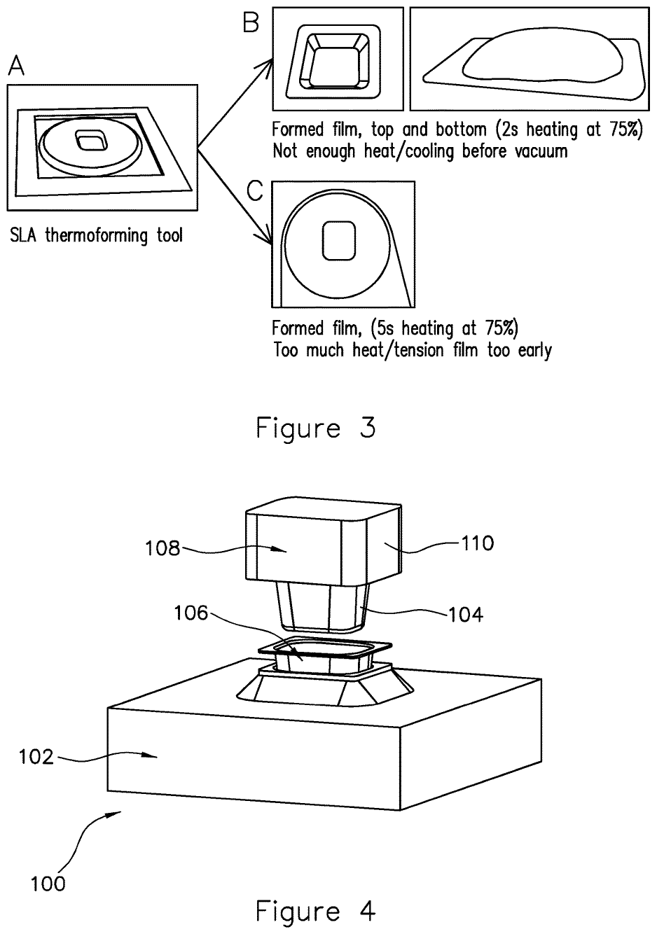

FIG. 3 show photographs of the application of a barrier film to a 3D moulded fibre tray using a SLA thermoforming tool, where (A) shows the SLA thermoforming tool, (B) shows the formed film on the top and bottom after 2 secs and heating at 75% and (C) shows the formed film after 5 secs and heating at 75%.

FIG. 4 is a perspective view of a plug assist tool that was used in order to assess whether the tool would be suitable for applying a barrier film to a 3D moulded fibre tray.

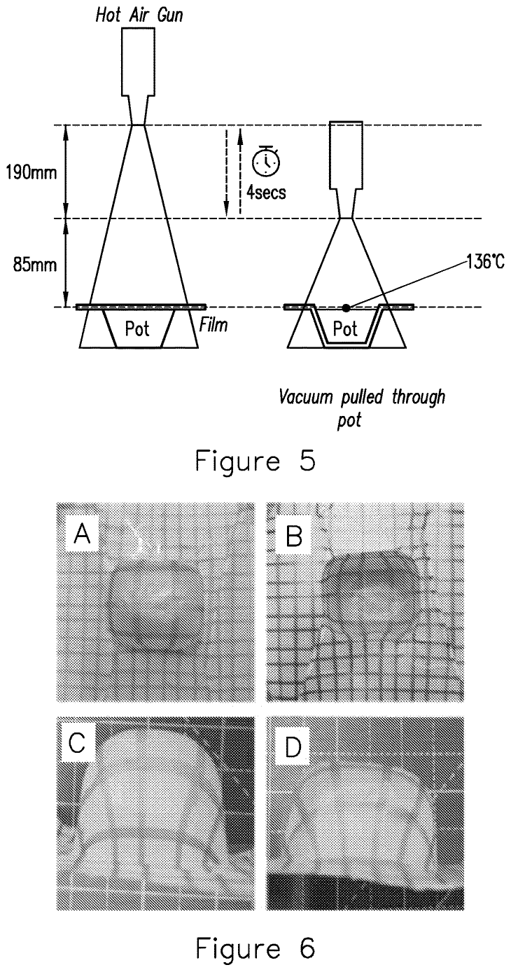

FIG. 5 is a schematic diagram of a process employed to apply the barrier film to a 3D moulded fibre tray.

FIG. 6 are photographs of a 150 μm barrier film which has been deformed and applied to a transparent 3D moulded tray, where (A) and (B) are plan views of the combined films and trays and (C) and (D) are side views of the combined films and trays.

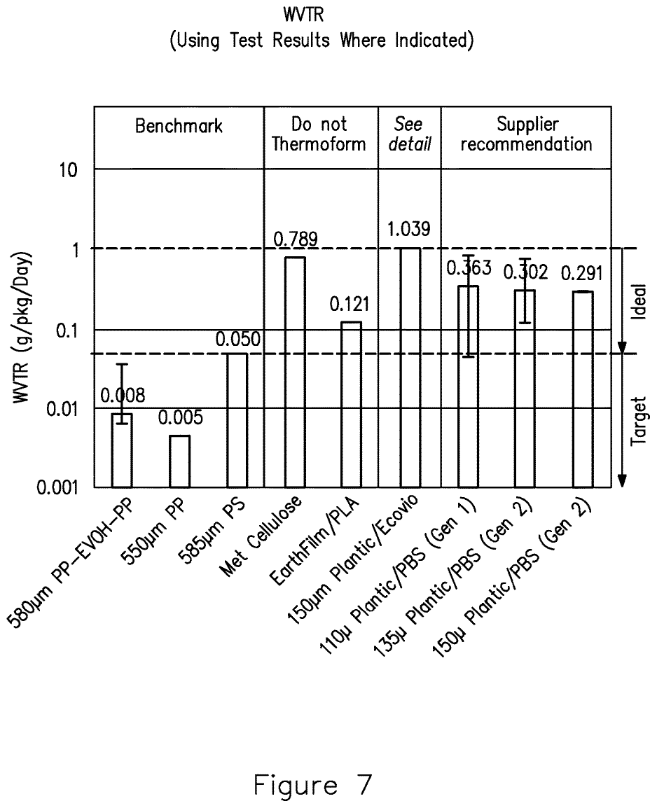

FIG. 7 is a graph showing the results of water vapor transmission rates (WVTR) of various barrier films which had been tested during trials.

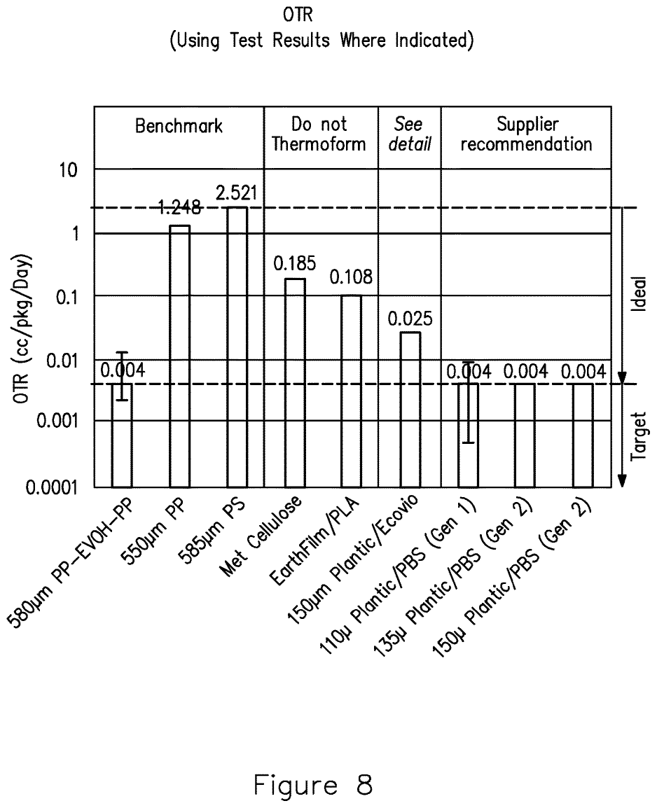

FIG. 8 is a graph showing the results of oxygen transfer rates (OTR) of various barrier films which had been tested during trials.

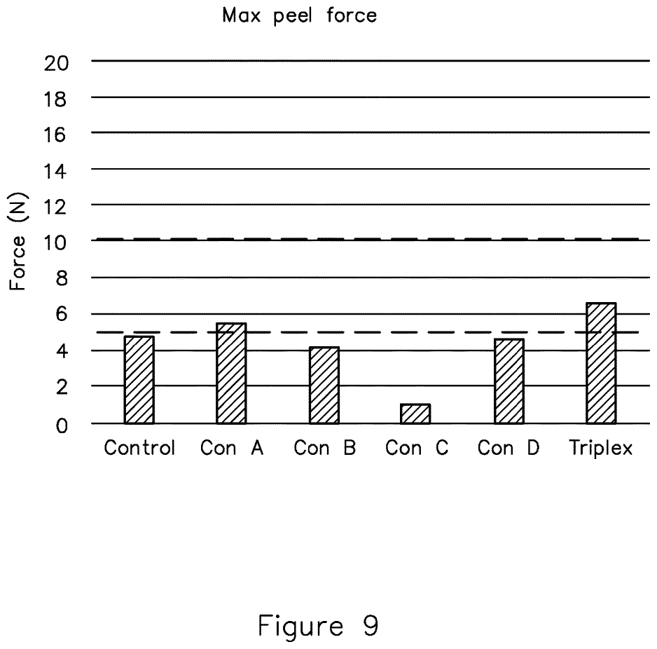

FIG. 9 is a graph showing the peel test results for the lidding film applied to the lined pots tested during the trials.

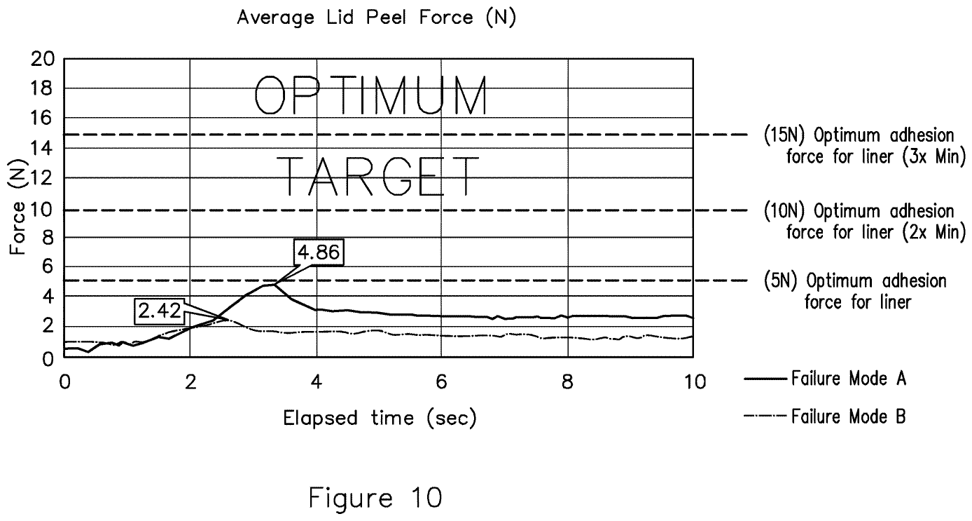

FIG. 10 is a graph plotting the lid peel benchmarking of a current plastics 3D moulded tray alongside the target adhesion strength.

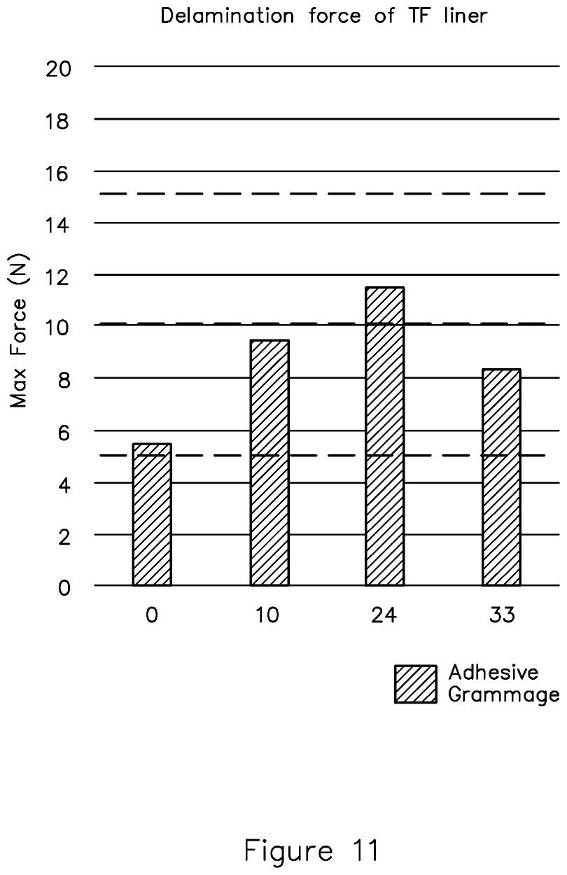

FIG. 11 is a graph showing the barrier liner adhesive force to the fibre pot alongside the adhesive grammage.

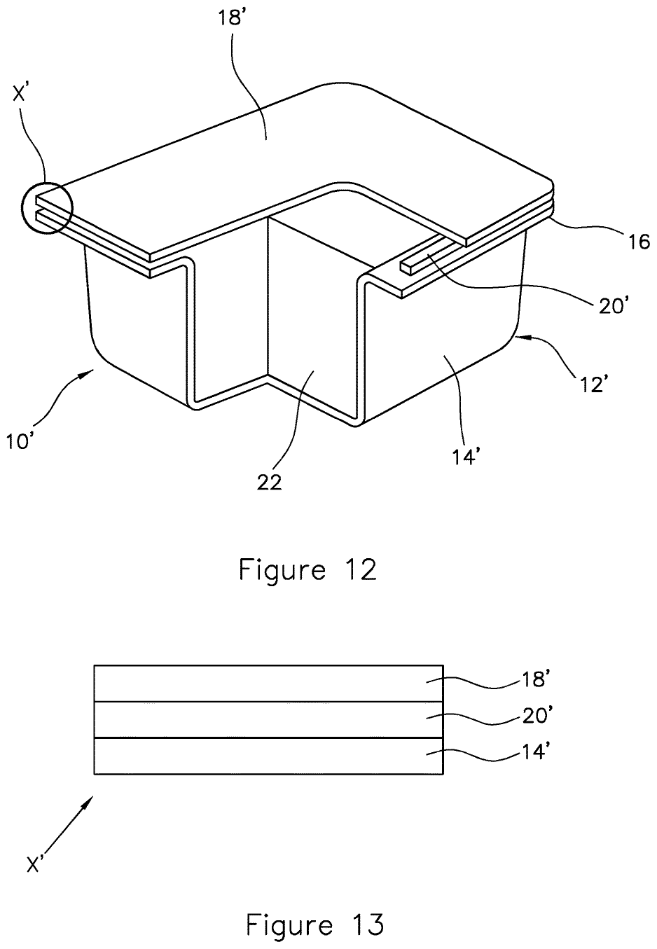

FIG. 12 is a perspective cut-away view of an alternative embodiment of a compostable packaging in accordance with the present invention.

FIG. 13 is a schematic cross-section of a compostable packaging as shown in FIG. 12.

### EXAMPLES

### Example 1-Compostable Sauce Container

FIG. 1 shows a compostable container in accordance with the present invention. The container 10 is formed of a compostable fibre moulded tray 12 having an interior surface covered with a composable barrier film 14. The moulded tray 12 has a lip 16 extending outwardly and around the opening of the tray and the barrier film 14 extends over the lip 16. A compostable lid 18 is adhered to the barrier film 14 around the lip 16 by means of a peelable adhesive 20. The container 10 shown in FIG. 1 also has a liquid foodstuff product 22 (such as tomato ketchup) being located within the tray 12. FIG. 2 shows a cross section of the area indicated X in FIG. 1 and shows the layering of the various components in the lip area to which the lid 18 is adhered.

The moulded tray 12 can be formed of any compostable material and can be wet or dry fibre moulded. In one embodiment, the moulded tray 12 is previously 3D moulded into the desired shape before the barrier film 14 is attached or applied to the inner surface. In another embodiment, the moulded tray 12 is 3D moulded into the desired shape at the same time as the barrier film 14 is applied to the inner surface—that is to say that the tray 12 and barrier 14 are moulded together at the same time. In certain embodiments, an adhesive (not shown) is used between the barrier film 14 and the moulded tray 12. In other embodiments, no adhesive is used between the barrier film 14 and the moulded tray 12 and the barrier film 14 adheres to the inner surface of the moulded try 12 by means of the forming or urging process or by means of spraying the barrier film 14 directly onto the moulded tray 12.

The moulded tray may be formed using a method of dry moulding a fibre substrate which utilises cellulose fibres. Such a method may form a multi-layer cellulose blank structure, wherein the method comprises the steps; forming the multi-layer cellulose blank structure from at least a first layer of dry-formed cellulose fibres and a second layer of a cellulose fibre web structure, through arranging the at least first layer and second layer in a superimposed relationship to each other and in the superimposed relationship arranging the at least first layer and second layer in contact with each other; arranging the multi-layer cellulose blank structure in a forming mould; heating the multi-layer cellulose blank structure to a forming temperature in the range of about 100° C. to about 300° C., and forming the cellulose product from the multi-layer cellulose blank structure in the forming mould, by pressing the heated multi-layer cellulose blank structure with an isostatic forming pressure of at least about 1 MPa, preferably 4-20 MPa, wherein the multi-layer cellulose blank structure is shaped into a two-dimensional or three-dimensional fibre composite structure having a single-layer configuration. Alternatively, the moulded tray may be formed by a method utilising a web of fibrous cellulosic material derived from wood pulp, said web being suitable for three-dimensional moulding to form a packaging product, wherein the web comprises about >40 wt % of soft wood chemical pulp and at least one strength enhancement agent, wherein the web has a grammage less than about 400 g/m², and wherein the cellulose fibres of said soft wood chemical pulp comprise a fibre curl of about >9%.

Alternatively, the moulded tray may be formed using a method of wet or semi-wet moulding a fibre substrate which utilises cellulose fibres, wherein a wet or semi-wet cellulosic material is conveyed to mould and the is formed into a 2D or 3D shape using a forming tool for forming a three-dimensional product out of the wet of semi-wet cellulosic material. The forming could be by means of thermoforming or other forming method which shapes and dries the cellulosic material to the shape of the mould.

The barrier film 14 can be formed of any suitable compostable film which has the appropriate moisture and oxygen barrier properties. The skilled addressee will appreciate that the moisture and oxygen barrier properties will be determined by the format and type of foodstuff to be held in the container. Typically, the container will be used for a fluid foodstuff with a relatively high water content, such as tomato ketchup. The moisture properties will need to prevent the egress of moisture from the foodstuff through to substrate used to form the moulded tray. The oxygen barrier properties will need to prevent the ingress of oxygen into the container so as to prevent unwanted oxidation of the foodstuff.

The barrier film 14 may be formed from a number of materials. The barrier film may be formed from a compostable bio-resin material. In one example, the barrier film 14 will be formed of one or more layers of modified polybutylene succinate (PBS).

The lid 18 may be formed from a number of materials. Preferably, the lid 18 is a formed of a composite cellulose and a polymeric material. More preferably, the lid 18 is a formed of a composite of cellulose and a polymer resin or cellulose and PBS. The cellulose may be methyl cellulose or other variant to cellulose. Typically, the lid will contain graphics and other printed material indicating the foodstuff in the container and instructions for peeling the lid and disposal after the use of the container. The graphics or other printed material will preferably be made from compostable and food safe inks.

The adhesive may be a food safe compostable heat seal.

### Example 2-Thermoforming Trials

Thermoforming trails were conducted on various barrier liners in order to assess the best method and liner to use in conjunction with a pre-formed 3D dry-formed moulded tray.

Two films were supplied for thermoforming trials, the first film being a 110 μm composite film formed of 30 μm/50 μm/30 μm layers, whereas the second film was a 150 μm composite film formed of 50 μm/50 μm/50 μm.

It will be appreciated that the film thicknesses described herein are only examples. In some trials, a film thickness in the range of about 150 μm to about 170 μm was utilised.

Phase 1—Thermal characteristics (110 μm film)

As shown in FIG. 3, the trial results indicate that the film does not thermoform like conventional films. The main observation is that heating the film too much or for too long makes it brittle. Additionally, it was anticipated from the beginning of this phase that a plug assist would be needed to fully form the liner into the pot and that vacuum alone wouldn't be sufficient. that using the SLA thermoforming tool, that

### Phase 2—Plug Assist Forming (110 μm Film)

To improve the forming % a plug assist tool was machined to apply pressure into the corners of the film. FIG. 4 shows an example of a plug assist tool, where the tool 100 is formed of a flat base 102 having a shaped cavity 104 which is shaped to the external dimensions of pre-formed tray 106 and a press 108 having a plug 110 extending downwardly towards the interior shaped cavity and the plug being shaped to the internal dimensions of the pre-formed tray 106. In use, press 108 operates to vertical direction to press the film (not shown) into the pre-formed tray when the plug 110 is urged against the shaped cavity 104. Unfortunately, this approach was deemed unsuccessful as the temperature sensitivity and crystallisation of the film meant that by the time the plug could reach into the mould (once the heater platen is retracted) the film already cooled and was no longer formable.

### Phase 3—Hot Air Gun Approach (110 μm Film)

Due to the sensitivity of forming the film a hot air gun was used to assess whether this method would assist in forming the barrier film to the interior surface of the pre-formed tray. The results of the trials were that >140° C. resulted in cracking, 120° C. to 140° C. resulted in good formation, whereas <120° C. resulted in poor formation.

Alternative trials were conducted in a range of about 100° C. to about 110° C. This was also found to result in good formation.

During the trials, bringing the film to temperature within a quick space of time (2-4 seconds) with a hot air gun approach was attempted. The concept is that the positive flow of heat against the film also assists the vacuum through the tray to help with forming but within a short (controllable) cycle time. This approach resulted in forming the 110 μm film approximately 70% into the pot.

Phase 4a—Positive Pressure Testing (110 μm Film)

Due to the encouraging results obtained from the hot air gun forming approach it was anticipated that by applying a high concentration of pressure and hot air flow while forming that the final stretching/flow of the film into the corners could be achieved. Positive pressure forming on the 110 μm film confirmed that this approach could result in an improved performance. A forming percentage of 81% was achieved. In addition to this, the positive pressure approach resulted in a low level of adhesion of the film against the pots (without the need of an adhesive on the film).

Phase 4b—Positive Pressure Testing Vs Hot Air Gun (150 μm Film)

Unfortunately, the 150 μm film did not give the same improvement using positive pressure forming compared to the hot air gun approach. It was found that the film would fill the cavity to a similar % as with the hot air gun. Due to the hot air approach being easier to control the results for the 150 μm film were calculated based on the hot air gun approach.

### Thermoforming Optimisation

The progression of trials to optimise the thermoforming conditions are detailed below in Table 1.

TABLE 1

| | | | | | | | | Result~% |
|---|---|---|---|---|---|---|---|---|
| | Heat | Film | Heating | Film | Heating | Vacuum | Plug | of final |
| ID | Method | Thickness | Temperature | Temperature | Time | level | Assist | form |
| 1 | Platen | 110 | 75% of max | ≈120° C. | 5 s | 75 cm | No | Bad / |
| | | | temperature | | | Hg | | Film |
| | | | | | | | | cracked |
| 2 | Platen | 110 | 50% of max | ≈120° C. | 5 s | 75 cm | No | Fair / |
| | | | temperature | | | Hg | | 50% |
| 3 | Platen | 110 | 30% of max | ≈120° C. | 5 s | 75 cm | No | Bad / |
| | | | temperature | | | Hg | | 30% |
| 4 | Platen | 110 | 30% of max | ≈120° C. | 3 s | 75 cm | No | Good / |
| | | | temperature | | | Hg | | 70% |
| 5 | Platen | 110 | Various | Various | Various | 75 cm | No | Poor to |
| | | | | | | Hg | | fair |
| 6 | Hot air | 110 | 100% | ≈120° C. | 4 s | Hg | No | 70% |
| 7 | Positive | 110 | 100% | ≈120° C. | 4 s | 75 cm | No | Good / |
| | pressure | | | | | Hg | | 81% |
| 8 | Platen | 150* | temperature | ≈120° C. | 4 s | Hg | No | 94% |
| 9 | Hot air | 150* | 100% | 136° C. | 4 s | 75 cm | No | V. Good |
| | | | | | | Hg | | 94% |

The final thermoforming parameters using the heat gun have been detailed in FIG. 5. It is believed that this is the optimal cycle to consistently form into the container.

To calculate the forming percentage of the liners, each liner was filled to brimfill capacity with water and the % fill weight was compared to the theoretical brimfill weight of 28 g.

100% Forming into the Pot (150 μm Film)

Thermoforming optimisation defined the optimal parameters (e.g. stretching each film to its threshold) for the 110 μm and 150 μm films. However, trials were able to show a maximum forming of 94%. It is believed that this is due to a discrepancy between the film specified and the film supplied for testing.

Material analysis measures the 150 μm film thickness to be closer to 136 μm in total as opposed to 150 μm. This means that thermoforming results correlate as follows:

$$\begin{matrix}110 μm ( 73 \% target thickness ) \to Max forming = 81 \% \\ 135 μm ( 90 \% target thickness ) \to Max forming = 94 \%\end{matrix}$$

It is reasonable to infer from these results the following:

$$150 μm film \to Max forming >= 100 \%$$

FIG. 6 shows the 150 μm film deformation pattern (when formed “Very Good” into cavity), where the line spacing=˜5 mm. Key observations were that very little stretch was observed to film surrounding the cavity (creases due to forming sequence & limitations of test equipment) and evidence of 100% forming.

The final thermoforming parameters using the heat gun have been detailed in FIG. 8. It is believed that this is the optimal cycle to consistently form into the pot.

To calculate the forming percentage of the liners, each liner was filled to brimfill capacity with water and the % fill weight was compared to the theoretical brimfill weight of 28 g.

### Example 3-Barrier Film Trials

3D barrier tests were conducted using a range of barrier films substrates and thicknesses for water vapour transmission rates and oxygen transfer rates and the results are shown in FIGS. 7 and 8 respectively.

The difference in water vapour transmission rates and oxygen transfer rates for various film thickness for 2D and 3D films are set out in Tables 2 and 3 respectively below.

TABLE 2

| | | OTR | | WVTR | |
|---|---|---|---|---|---|
| | | (23° C./65% rh) | | (38° C./90% rh) | |
| | | cm³/m²/day | | g/m²/day | |
| Film Thickness | | Theoretical | Actual | Theoretical | Actual |
| Benchmark | | 0.11 | N/A | 0.27 | N/A |
| 110 | μm | 1.05 | 1.2 | 70.0 | 64.0 |
| 135 | μm* | N/A | N/A | 66.6 | TBC |
| 150 | μm | 1.05 | TBC | 40 | 38.5*** |

TABLE 3

| | | OTR | | WVTR | |
|---|---|---|---|---|---|
| | | (23° C./65% rh) | | (38° C./90% rh) | |
| | | cm³/m²/day | | g/m²/day | |
| Film Thickness | | Theoretical | Actual | Theoretical | Actual |
| Benchmark | | N/A | 0.004_{(4 reps)} | 0.05 | N/A |
| 110 | μm | 0.010 | 0.004_{(2 reps)} | 0.53 | 0.362_{(3 reps)} |
| 135 | μm* | N/A | N/A | N/A | 0.302_{(3 reps)} |
| 150 | μm | 0.009 | TBC | 0.291 | TBC |

The results showed that 81% of packs were formed for the 110 μm film, whereas 94% of packs were formed for the 135 μm film.

These trials illustrated that the oxygen barrier achieved in 3D form was very good and directly comparable to the current best performing containers using a plastics tray.

The water vapour transmission, was slightly higher than the current best performing container using a plastics tray, however this was in range of the theoretical barrier and could still be incrementally improved using a 150 μm film.

The formed 3D pots used for testing were formed; 81% for 110 m film and 94% for 135 μm film. This was due to the limitation of thermoforming/film stretch.

All successful tests performed to date show that 150 μm film based on a modified PBS substrate was suitable to move forward into shelf life testing studies.

### Example 4-Lidding Film Trials

The purpose of these trials were to investigate whether certain preferred lidding films were compatible with heat sealing against the preferred modified PBS barrier film and whether a biodegradable adhesive provided a strong enough bond when activated during the thermoforming process.

Test films used within the trials are detailed in Table 4 below.

TABLE 4

| | |
|---|---|
| ModPBS 50/Plantic 50/ModPBS 50 | Thermoformed pot Liner |
| Current foil lidding film | Baseline |
| Pap 40/PBS 20/MetPAP 23/PBS 20 | Lid Film |
| Pap 40/PBS 20/TransPAP 23/PBS 20 | Lid Film |
| Pap 40/MetCellulose 23/Cellophane 20 | Lid Film |
| Pap 40/Cellulose 19/Cellophane 20 | Lid Film |
| 5 gsm Paper/23 mu Cellulose/30 mu Bio-HSL | Lid Film |

Test preparation and parameters were as follows: Test Strip: 25 mm×150 mm; Sealing Temperature: 120° C. (Max temperature that can be applied before negatively affecting liner);

Sealing Pulse: 1 sec; Sealing Pressure: 450 lbf; Test Method: ASTM D1876 (T Peel); and Peel Rate: 300 mm·min⁻¹.

FIG. 9 compares the results from the peel testing against the target level of 5N. It also shows that all values are significantly lower than the defined upper limit of 10N.

The peeled test strips were visually assessed as to their mode of failure, as detailed in Table 5 below.

TABLE 5

| Variant | Mode of failure |
|---|---|
| Control | Peel Seal |
| Con A | Peel Seal |
| Con B | Peel Seal |
| Con C | Peel Seal |
| Con D | Peel Seal |
| Triplex | Delamination of pot liner |

Film variants with a PBS heat seal layer were consistently providing a more secure bond to the liner film. Although Con D appears to be comparable to Con B, the variability in the results was relatively large and therefore there would be more confidence in progressing with the two films that are based on PBS as the adhering layer due to the consistency of results.

The peel strength of both Con A & Con B is in the target force region.

The peel strength of the Triplex film appears to give the maximum bond force to the liner due to the force required to peel resulting in delamination of the liner. This should be considered as the “bullet proof” option moving forward and could be used for tests where liner peel-ability is not part of the assessment criteria, but a secure bond is needed.

### Example 5-Adhesive Trials

Trials were conducted in order to identify the best peelable adhesive to use. There are several methods of applying an adhesive into the construction of the pots, each of which having different levels of complexity to implement and maintain (from a process quality perspective).

To determine the benchmark force required for the adhesive to target, peel testing was conducted on the current McCormick pots to show the peak force that is deemed sufficient for consumer use. A bespoke test rig was created to conduct this peel assessment. Table 6 details the specification of the variant tested and calls out 2 distinct failure forces found across the 10 replicates assessed.

TABLE 6
TK Pot - 21 ml

| Lidding Film | ALU 12/Adhesive/PET12/HSL 36 | |
|---|---|---|
| Bottom Web/Liner | PP | |
| Failure Mode | A | B |
| Average Max Peel Force (N) | 4.86 | 2.42 |
| Max peel force (N) | 5.15 | 2.67 |
| Equiv Max Peel force (N) | 8.9N | n/a |
| 10 mm 2D strip | | |

To be on the side of caution, the trails focused on obtaining a safety factor higher than the maximum average force recorded. A visual of how this can be represented is in FIG. 10, where the target of 10-15N has been defined as the target range for the liner adhesion and 5N has been defined as the lidding film adhesion force. The peel rate was 120 mm·min⁻¹.

Of all the variants tested, a biodegradable adhesive was found to be compatible both with thermoforming, The Plantic/Modified PBS film and moulded dry fibre tray substrate. As shown in FIG. 11, liner peel testing also indicates that a dry grammage of approximately 24 gsm provided enough adhesion to the liner to result in delamination of the pulp pot inner layer. This is the maximum adhesive force obtainable.

The biodegradable adhesive selected was a paper and biofilm heat seal adhesive with direct food contact approval. The recommended sealing conditions are >100° C. at 20 psi for 0.5 seconds.

The adhesive was applied onto the modified PBS substrate at a dry coat weight of 14 gsm, but experiments suggested that a range of 10-24 gsm would also be acceptable.

The adhesive is a mixture of 5-Chloro-2-methyl-4-isothiazolin-3-one [EC No 247-500-7] {3 parts of} and 2-Methyl-4-isothiazolin-3-one [EC No 220-239-6] {1 part of}, and has the following properties:
Appearance: Off-White liquid
Viscosity: 150 cP approx. Brookfield sp2, 50 rpm, 20° C.
Solid Content: 40% approx.
Specific Gravity: 1.05 g/ml approx.
PH: 8-9
Cleaning: Water
Shelf life: 6 months

Advantageously, the adhesive is compatible with thermoforming, the modified PBS barrier liner film and the moulded fibre substrate, whilst being compostable and food-safe.

### Example 6-Alternative Compostable Sauce Container

FIG. 12 shows an alternative compostable container 10′ in accordance with the present invention. The alternative compostable container 10′ is similar to the compostable container 10 as shown in FIG. 1 (and FIG. 2). However, the container 10′ does not require a compostable moulded fibre tray 12, but rather the tray (and barrier film) is formed of a single material, such as a thicker barrier film, so as to form the barrier itself.

The container 10′ is formed of a compostable moulded tray 12′. The compostable moulded tray 12′ forms a barrier film 14′. In this example, the tray 12′ is formed of a barrier film 14′, and in this way the tray 12′ itself forms the barrier film 14′. This may alternatively be described as the tray 12′ providing the barrier film 14′. In relation to the alternative container 10′, the barrier film 14′ may be said to be a “barrier layer 14” and to actually form the barrier. The moulded tray 12′ has a lip 16′ extending outwardly and around the opening of the tray 12′. A compostable lid 18′ is adhered to the barrier film 14′ around the lip 16′ by means of a peelable adhesive 20′. Similar to the container 10 shown in FIG. 1, the container 10′ shown in FIG. 12 has an interior cavity in which a liquid foodstuff product 22′ (such as tomato ketchup) is received.

FIG. 13 shows a cross section of the area indicated X′ in FIG. 12 and shows the layering of the various components in the lip area to which the lid 18′ is adhered. In FIG. 13, the cross section X′ of a compositable container is shown which is formed of a thick moulded composable barrier film 14′. A compostable lid 18′ is adhered to the barrier film 14′ by means of a peelable adhesive 20′. By omitting the moulded dry fibre tray component, and forming the tray using the barrier film (e.g., using the same material as the barrier film), fewer components are utilized which improves efficiency of production and reduces costs and time of manufacturing.

In the embodiment shown in FIGS. 12 and 13, the thick moulded compostable barrier film 14′ may be formed by lamination of multiple layers or via extrusion prior to, or during shape forming. Preferably, the thickness of the barrier film 14′ is in the range of about 100 μm to about 600 μm, for example in the range of about 400 μm to about 600 μm. Most preferably, the thickness of the barrier film 14′ is about 400 μm and is formed of three layers where each layer is approximately 130 μm thick. In embodiments, each layer is formed of a compostable bio-resin material. In certain embodiments, each layer is formed of the same modified PBS material. In other embodiments where a more robust barrier is required, the middle layer may comprise a compostable material which is an oxygen scavenger. Such middle layers may comprise vegetable byproducts, such as those derived from coffee bean skins.

Manufacturing parameters and performance parameters of the embodiment of FIGS. 12 and 13 can be understood from Table 7 below, in which the embodiment is compared with a container of similar construction formed from a polypropylene (PP) barrier film:

TABLE 7

| | | Alternative Compostable |
|---|---|---|
| | | Sauce Container formed of |
| | | a compostable bio-resin |
| Parameter | PP | material |
| Thermoforming | 135° C.- | about 105° C. |
| temperature | 170° C. | to about 120° C. |
| Thermoforming dwell time | 700 ms | ≤700 ms |
| Sealing temperature | 200° C. | ≤200° C. |
| Water Vapour Transmission | <0.005 | 0.100-0.200 |
| Rate (WVTR) - determined | g/package/day | g/package/day |
| in accordance with ASTM | | |
| F1249-20, where the pot | | |
| was purged with a dry gas | | |
| while the outside was | | |
| exposed to air at | | |
| 38 ± 2° C., 90 ± 5% RH | | |

From the above Table 7, it will be appreciated that the alternative container may be formed at lower thermoforming temperatures, thereby reducing energy usage and reducing degradation of equipment used in the thermoforming process. Additionally, by thermoforming at lower temperatures, quicker manufacture can be facilitated as heat-up times and/or cooling times can be reduced.

Furthermore, dwell time is reduced compared with similar containers formed from PP barrier film. Advantageously, this reduces energy usage and reduces degradation of manufacturing equipment.

Furthermore, lower sealing temperatures may be used. Advantageously, this reduces energy usage and reduces degradation of manufacturing equipment. This also increases speed of the manufacturing process.

Notably, from the above, it will be appreciated that the WVTR is improved.

The optional features set out herein may be used either individually or in combination with each other where appropriate and particularly in the combinations as set out in the accompanying claims. The optional features for each aspect or exemplary embodiment of the invention as set out herein are also to be read as applicable to any other aspect or exemplary embodiments of the invention, where appropriate. In other words, the skilled person reading this specification should consider the optional features for each exemplary embodiment of the invention as interchangeable and combinable between different exemplary embodiments.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, and drawings), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, and drawings), or to any novel one, or any novel combination, of the steps of any method or process so disclosed.

1. A compostable food packaging comprising:
a) a compostable moulded tray having an interior cavity for receiving a foodstuff, an opening through which the foodstuff can be accessed, and a lip extending at least partially around the opening;
b) wherein the compostable moulded tray forms a compostable barrier, or wherein the compostable moulded tray further comprises a compostable barrier film extended over, and bonded to, the interior cavity and lip of the tray by means of a paper and biofilm heat seal adhesive; and
c) a compostable lid which is peelably adhered around the opening and extending to the lip using a peelable adhesive.

2. The food packaging of claim 1, wherein the barrier or barrier film is formed of a compostable bio-resin material, optionally wherein the barrier or barrier film is formed of multiple layers.

3. (canceled)

4. The food packaging of claim 1, wherein the compostable moulded tray is a compostable moulded fibre tray, optionally a compostable dry moulded fibre tray.

5. The food packaging of claim 1, wherein the compostable moulded tray comprises a compostable barrier film extended over, and bonded to, the interior cavity and lip of the tray by means of a paper and biofilm heat seal adhesive, and wherein the barrier film is greater than or equal to about 110 μm thick, optionally wherein the barrier film is greater than or equal to about 135 μm thick, optionally wherein the barrier film is greater than or equal to about 150 μm thick, optionally wherein the barrier film is in the range of about 150 μm to about 170 μm thick.

6-8. (canceled)

9. The food packaging of claim 1, wherein the heat seal adhesive is applied at a dry coat weight in the range of about 10 gsm to about 24 gsm, optionally wherein the heat seal adhesive is applied at a dry coat weight in the range of about 12 gsm to about 20 gsm, optionally wherein the heat seal adhesive is applied at a dry coat weight in the range of about 14 gsm.

10-11. (canceled)

12. The food packaging of claim 1, wherein the barrier or barrier film is at least partially spray coated to the tray or impregnating within the tray.

13. The food packaging of claim 1, wherein the compostable moulded tray forms a compostable barrier film, wherein the barrier film is in the range of about 400 μm to about 600 μm thick, optionally wherein the compostable moulded tray forms a compostable barrier film, wherein the compostable moulded tray and compostable barrier film are integrally formed.

14. (canceled)

15. The food packaging of claim 1, wherein the lid comprises cellulose and a polymer.

16. The food packaging of claim 1, wherein the heat seal adhesive comprises a polyurethane, optionally wherein the polyurethane comprises one or more of the following: 5-Chloro-2-methyl-4-isothiazolin-3-one and/or 2-Methyl-4-isothiazolin-3-one.

17. (canceled)

18. The food packaging of claim 1, further comprising a foodstuff within the cavity, optionally wherein the foodstuff is a liquid foodstuff, optionally wherein the foodstuff is a sauce, optionally wherein the sauce is selected from one or more of the following: tomato ketchup, barbeque sauce, mayonnaise, mustard sauce, chili sauce, ranch dressing, curry sauce, and sweet and sour sauce.

19-21. (canceled)

22. A method of producing a compostable food packaging comprising:
a) providing a compostable moulded tray having an interior cavity for receiving a foodstuff and an opening through which the foodstuff can be accessed and a lip extending at least partially around the opening;
b) wherein the providing the compostable moulded tray forms a compostable barrier, or wherein the method further comprises applying and/or forming and bonding, by means of a paper and biofilm heat seal adhesive, a compostable barrier film over the interior cavity and lip of the tray;
c) providing a compostable lid and applying it around the opening and at least part of the lip by means of a peelable adhesive; and
d) urging the lid against the opening under heated conditions so as to heat seal the cavity using the lid.

23. The method of claim 22, wherein the method comprises applying and/or forming and bonding, by means of a paper and biofilm heat seal adhesive, a compostable barrier film over the interior cavity and lip of the tray, wherein the barrier film is applied to the interior cavity and lip of the tray by applying hot air to the film and applying negative pressure to an exterior of the tray, optionally wherein the hot air is in the range of about 100° C. to about 140° C., optionally wherein the hot air is in the range of about 100° C. to about 110° C., optionally wherein the hot air is dispensed using a hot air gun.

24-26. (canceled)

27. The method of claim 23, wherein the hot air gun is moved from a distance of about 200 mm from the barrier film to about 100 mm from the barrier film for up to about 2 to about 4 seconds, optionally wherein the hot air gun is moved from a distance of about 190 mm from the barrier film to about 85 mm from the barrier film for up to about 4 seconds.

28. (canceled)

29. The method of claim 22, wherein the method comprises applying and/or forming and bonding, by means of a paper and biofilm heat seal adhesive, a compostable barrier film over the interior cavity and lip of the tray, wherein the barrier film is at least partially applied to the interior cavity and lip of the tray by spray coating.

30. The method of claim 22, wherein step d) is undertaken at about 120° C. and/or at about 450 lbf and/or for about 1 second.

31. The method of claim 22, wherein the providing the compostable moulded tray forms a compostable barrier, wherein the compostable barrier is thermoformed at a temperature in the range of about 100° C. to about 170° C., preferably at a temperature in the range of about 100° C. to about 120° C., most preferably in a range of about 105° C. to about 120° C., optionally wherein the compostable barrier is thermoformed with a thermoforming dwell time of less than about 1000 ms, preferably with a thermoforming dwell time of less than about 800 ms, most preferably with a thermoforming dwell time of less than about 700 ms.

32. (canceled)

33. The method of claim 22, wherein step d) is formed at a temperature of less than about 200° C., preferably at a temperature of at or less than 170° C., most preferably at a temperature in a range of about 160° C. to 170° C.

34. The method of claim 22, wherein the compostable moulded tray forms a compostable barrier, wherein the compostable moulded tray and compostable barrier are integrally formed.

35. The method of claim 22, wherein prior to step c), a liquid food stuff is placed in the cavity.

36. The method of claim 22, for producing a compostable food packaging of claim 1.
